(19) United States
(12) Patent Application Publication
(10) Pub. No.: US 2004/0267677 A1
(43) Pub. Date: Dec. 30, 2004

(54) Packing and shipping management system and packing and shipping management method

(76) Inventors: Minoru Mitsuoka, Aichi-ken (JP); Masato Matsuzaki, Aichi-ken (JP)

Correspondence Address: MORGAN & FINNEGAN, L.L.P., 3 WORLD FINANCIAL CENTER, NEW YORK, NY, 10281-2101, US

(21) Appl. No.: 10/872,551

(22) Filed: Jun. 21, 2004

(30) Foreign Application Priority Data
Jun. 25, 2003 (JP) 2003-180758

(51) Int. Cl. G06F 17/60

(52) U.S. Cl. 705/400

(57) ABSTRACT

An order reception management server creates order information in accordance with an order placed by a customer. A production management server requests a manufacturer to manufacture parts or products to be shipped in accordance with the order information and issues an order for packing boxes, in which the parts or products are packed, to a packing box manufacturer. As the parts or products are delivered from the manufacturer, a packing instruction creating unit outputs a packing instruction sheet, which gives instructions on how the parts or products are to be packed. Following the instructions of the instruction sheet, a worker carries out packing work and notifies a packing and shipping management server of the result of the packing work.

### BACKGROUND OF THE INVENTION

1. Field of the Invention

The present invention relates to a packing and shipping management system and a packing and shipping management method to manage or assist packing and shipping of products or parts.

2. Description of the Related Art

There has always been strong demand for a more efficient way to pack and ship products or parts that are lined up upon order. As an answer to this demand, recent years have found computer-operated systems designed to manage a process starting from reception of an order for products or parts and ending with shipment of the products or parts.

An example of such systems is disclosed in JP 2000-085927 A. The publication introduces a method of avoiding troubles due to a worker misreading a shipping form or other similar reasons. Specifically, the method includes the steps of: reading an identifier attached to each product as the products are lined up for shipping; notifying a worker of whether the gathered products are correct ones or not based on the reading of the identifier; attaching a label, which contains an identifier, to each product to be shipped during packing; and reading the label upon loading into a truck to notify a worker of whether or not correct products are loaded into the truck. Those steps are managed by a server computer.

JP 2001-315917 A and JP 2002-087541 A disclose methods in which an IC card is attached to each article to be packed. When articles with IC cards are gathered and packed into one package, time data is written in the IC cards of the articles at regular time intervals. The time data is read from the IC cards of the articles at once upon shipping of the articles to check whether or not there is an item missing by checking regularity of the time data read out. Instead of time data, ID unique to each article may be used.

JP 2003-122420 A discloses a system for total management from reception of parts to shipment of finished products which utilizes parts quality information, process quality information, and product quality information inputted in a parts inspection zone, a production zone, and a product inspection zone. This system has a logistics support server to manage product shipment and inventory.

As a few examples are given in the above, systems which use computers to manage packing/shipping work in a factory are known technologies. However, every existing system is built on the premise that products or supplies are stocked; the premise on which any existing system is built is that parts from parts manufacturers or the like are kept for a time as an inventory in a warehouse and the parts are then retrieved from the warehouse for shipping.

In order to improve the productivity in manufacturing factories, parts distribution bases, and the like, it is desirable to carry as small a stock as possible, or even better, none at all. To the knowledge of the applicant, no system has been designed to manage or assist packing/shipping of products or parts on the premise of carrying no inventory.

### SUMMARY OF THE INVENTION

The present invention has been made in view of the above, and an object of the present invention is therefore to provide a packing and shipping management system and a packing and shipping management method which can improve the work efficiency for the process from reception of an order for parts or products to shipping of the order.

A packing and shipping management system according to the present invention includes: order reception management means for creating order information in accordance with an order placed by a customer; production management means for ordering articles to be shipped based on the order information; and packing instruction creating means for creating and outputting packing instructions in accordance with the order information upon reception of the ordered articles to be shipped, the packing instructions instructing a packing worker on how the articles are to be packed.

According to the present invention, packing instructions are created and outputted as soon as an article to be shipped is received and therefore a received article can be shipped immediately without being kept as an inventory. The packing instruction creating means, which creates packing instructions, operates in conjunction with the order reception management means, which receives an order from a customer, and the production management means, which orders an article to be shipped. The overall work efficiency from reception of an order for an article to shipment of the order is thus improved.

The above packing and shipping management system may be structured such that the production management means orders a packing box for packing articles to be shipped in accordance with the order information and that the packing instruction creating means adds, to the packing instructions, information specifying what packing box is to be used. This structure makes it possible to avoid a situation where articles to be shipped are packed in a wrong packing box.

Further, the above packing and shipping management system may be structured such that the system further includes an article-packing box correspondence table which registers, for each article to be shipped, information specifying what packing box is to be used in packing articles and information indicating a maximum number of the articles that can be packed in the packing box, and that the production management means determines a type and number of packing boxes to order by consulting the article-packing box correspondence table. This structure makes it possible to prepare as many packing boxes suitable for articles to be shipped as necessary and not more or less.

Further, the above packing and shipping management system may be structured such that the packing instruction creating means indicates the packing instructions on an instruction sheet that is to be handed to a packing worker. With this structure, a worker can receive an instruction sheet which instructs the worker on specifics of the packing, thus rendering erroneous packing only a very remote possibility.

### BRIEF DESCRIPTION OF THE DRAWINGS

In the accompanying drawings:

FIG. 1 is an overall structural diagram of a packing and shipping management system according to an embodiment of the present invention;

FIG. 2 is a flow chart showing the operation of an order reception management server;

FIGS. 3A to 3C are diagrams showing an example of order data, an example of a specification database, and an example of order development data, respectively;

FIG. 4 is a flow chart showing the operation of a production management server;

FIGS. 5A and 5B are diagrams showing an example of production request data and an example of packing box data, respectively;

FIG. 6 shows an example of a parts-packing box correspondence table;

FIG. 7 is a flow chart showing the operation of a packing instruction creating unit;

FIG. 8 shows an example of a packing instruction sheet; and

FIG. 9 is a block diagram of a computer for running the packing and shipping management system.

### DESCRIPTION OF THE PREFERRED EMBODIMENT

An embodiment of the present invention will be described below with reference to the accompanying drawings.

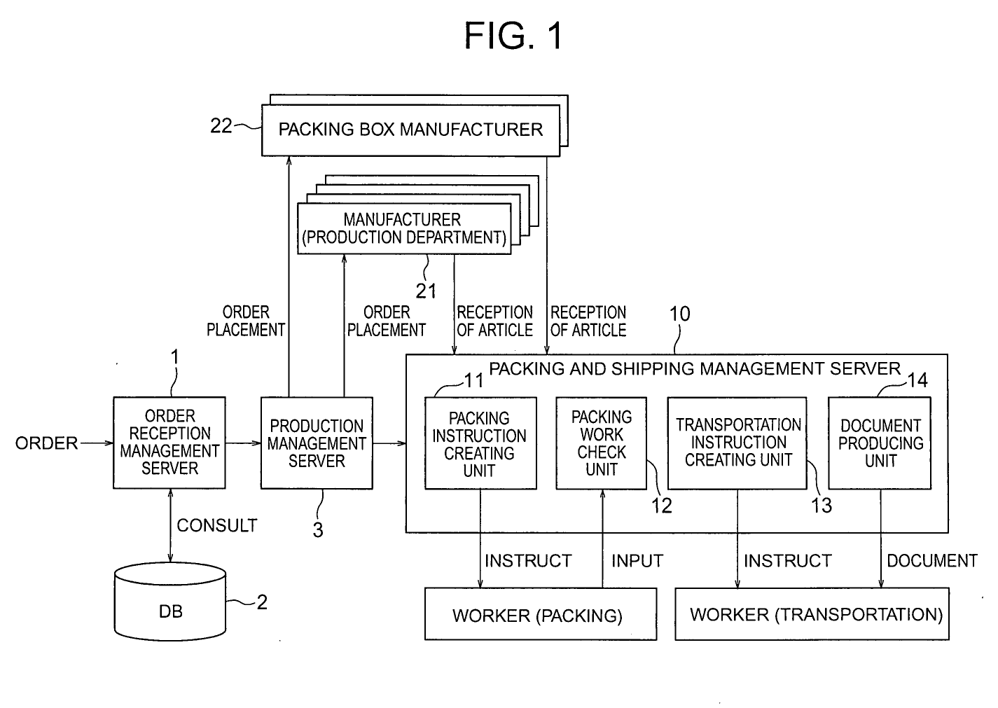

FIG. 1 is an overall structural diagram of a packing and shipping management system according to an embodiment of the present invention. The packing and shipping management system of this embodiment has a packing and shipping management server 10, an order reception management server (order reception management means) 1, a specification database 2, and a production management server (production management means) 3. In the packing and shipping management system, the packing and shipping management server 10 manages packing and shipping of articles to be shipped while cooperating with the order reception management server 1, which manages orders from customers, and the production management server 3, which manages production of articles to be shipped.

The order reception management server 1, the production management server 3, and the packing and shipping management server 10 are usually computers different from each other. When this is the case, the servers 1, 3, and 10 are preferably connected to each other via LAN or the like. Alternatively, the servers 1, 3, and 10 may each be a group of computers. If the packing and shipping management system to be built is a small-scale system, one computer may serve as the order reception management server 1, the production management server 3, and the packing and shipping management server 10 all by itself.

Articles to be shipped are not limited to particular items, and may be products (for example, weaving machines, fine spinning machines, and other textile machineries) or parts that constitute the products. In the case of an order for a large-sized machine product, for example, which is to be assembled after delivery to the customer, multiple types of parts (or units) constituting the machine are shipped.

Described below is the structure and operation of the packing and shipping management system of this embodiment for a case in which a customer places an order for a product, and parts and other relevant items of the product are shipped to the customer.

The order reception management server 1 is set in, for example, a sales department to receive an order from a customer, and creates order information (including order data and order development data which will be described later).

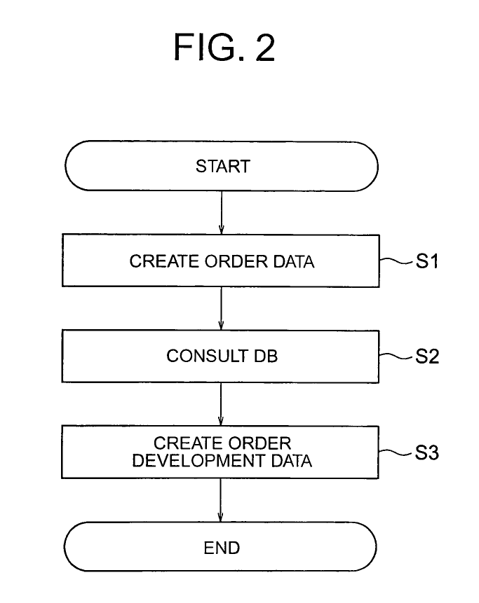

FIG. 2 is a flow chart showing the operation of the order reception management server 1. The processing shown in FIG. 2 is implemented upon reception of an order placed by a customer via Internet, phone, FAX, or the like.

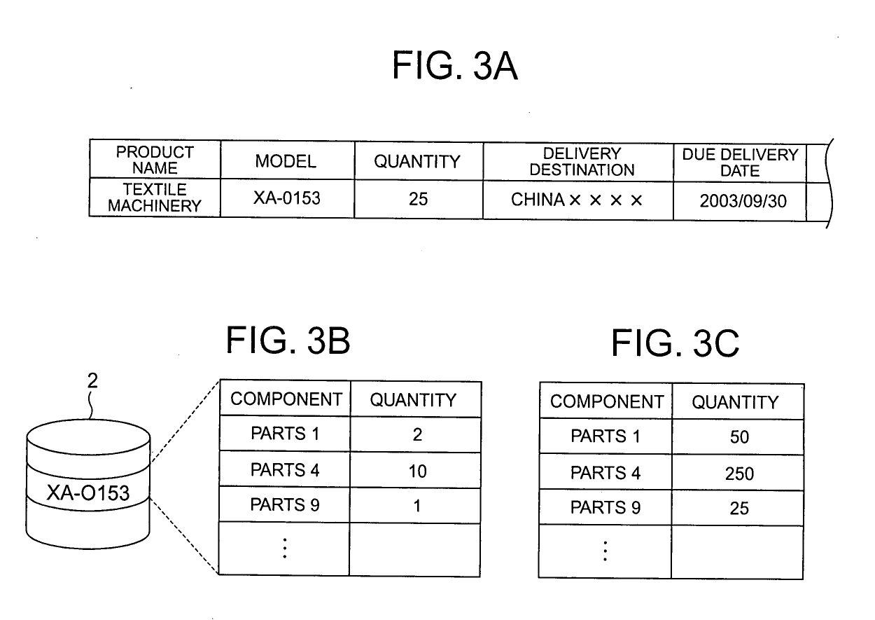

In step S1, order data is created in accordance with an order from a customer. Order data is data indicating the name, model, and quantity of the product ordered, where to deliver, due delivery date, etc., as shown in FIG. 3A.

In steps S2 and S3, the specification database 2 is consulted to create order development data. The specification database 2 stores product specifications which describe constituent parts of each product. FIG. 3B shows an example of specification, which tells that a product “XA-0153” is composed of two of Parts 1, ten of Parts 4, one of Parts 9, and so on. Order development data is obtained by developing order data in accordance with a specification stored in the specification database 2. FIG. 3C gives an example of order development data which is obtained by developing the order data of the order for the product “XA-0153” and which shows that the number of parts necessary to fulfill the order is 50 for Part 1, 250 for Part 4, 25 for Part 9, and so on.

The production management server 3 is set in, for example, a production management department or an order placement department to place an order for the parts corresponding to the ordered product to one or more manufacturers (including production departments of its own) 21 in accordance with the order information. The production management server 3 also issues an order for a packing box for packing the parts to be shipped, to one or more packing box manufacturers 22.

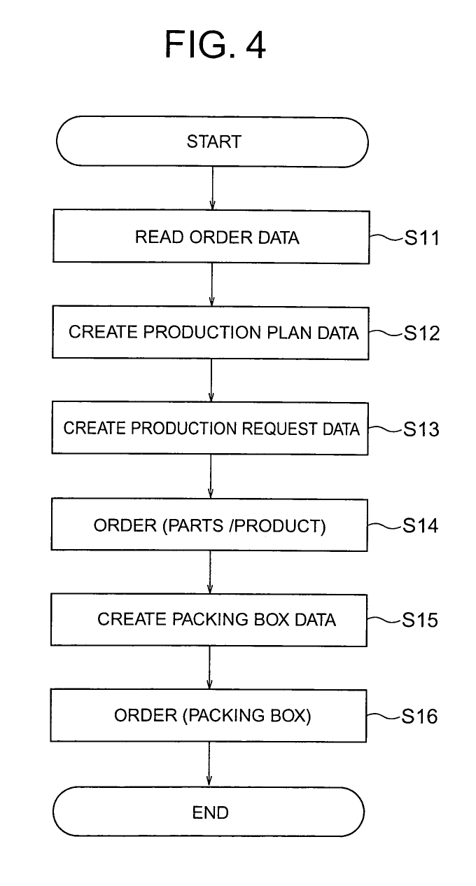

FIG. 4 is a flow chart showing the operation of the production management server 3. The processing shown in FIG. 4 is implemented upon creation of order information by the order reception management server 1.

In step S11, the order information (order data and order development data) created by the order reception management server is read. In step S12, production plan data is created. Due delivery date, quantity, past performance, and the like are taken into consideration in creating production plan data.

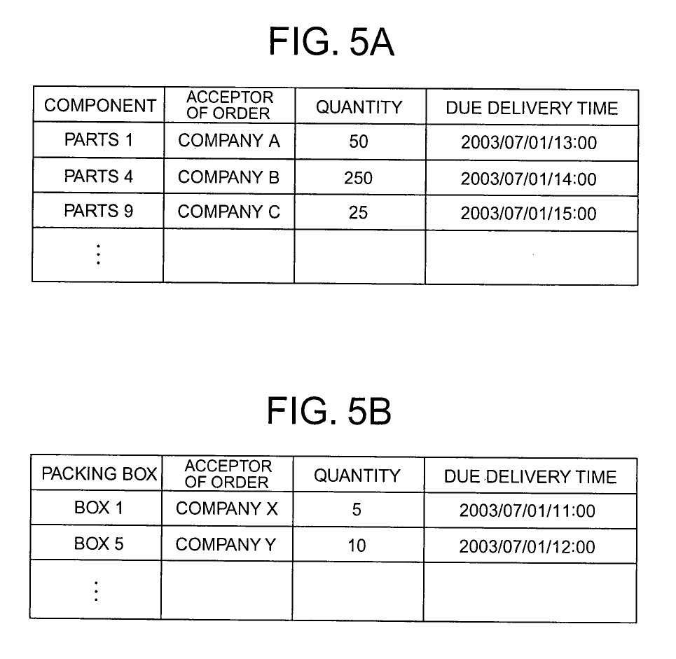

In step S13, production request data is created based on the order information and the production plan data. As shown in FIG. 5A, for instance, production request data is created for each of the parts that constitute the ordered product, and includes such information as “acceptor of order”, “quantity”, and “due delivery date”. In step S14, the production request data is used to issue an order for the parts to the one or more manufacturers 21.

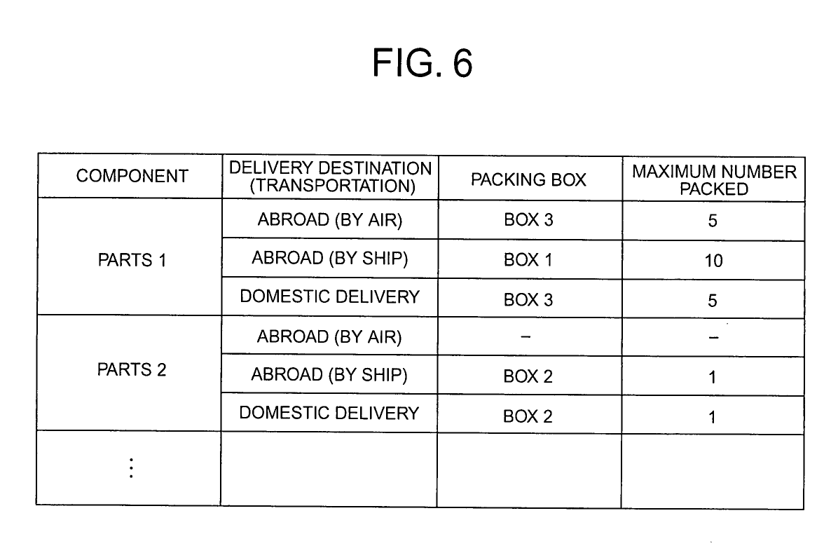

In step S15, packing box data is created based on the order information and the production plan data. At this point, a consultation is made to a parts-packing box correspondence table shown in FIG. 6. Registered in the parts-packing box correspondence table for the respective parts (in some cases, for each product or unit) are information specifying what packing box is to be used in packing the parts, information indicating the maximum number of parts that can be packed, and the like. If the type of packing box used varies depending on the delivery destination or on the mode of transportation, the information is registered corresponding to each packing box type or each delivery destination. In the example shown in FIG. 6, “Packing Box 3” is specified for “Parts 1” when the parts are to be shipped abroad by air or in the case of domestic delivery, whereas “Packing Box 1” is specified for “Parts 1” when the parts are to be shipped abroad by sea. The table also shows that up to one hundred pieces of “Parts 1” can be packed in one “Packing Box 1” whereas one “Packing Box 3” can hold up to 50 pieces of “Parts 1”. Generally speaking, corrugated boxes are often used for transportation by air in order to lessen the cargo weight whereas wooden boxes are used for transportation by sea in preference to sturdiness.

Packing box data is created for each packing box type as shown in FIG. 5B, for example, and includes such information as “acceptor of order”, “quantity”, and “due delivery date”. The packing box data is used in step S16 to place an order for the parts to the one or more packing box manufacturers 22.

Creation of production request data and packing box data is timed such that packing boxes for packing parts of interest are delivered from the packing box manufacturers 22 in advance prior to the arrival of the parts from the manufacturers 21. In the example shown in FIGS. 5A and 5B, when “Packing Box 1” is used to pack and ship “Parts 1”, “Due Delivery Time” of “Packing Box 1” specified by the packing box data is set two hours earlier than “Due Delivery Time” of “Parts 1” specified by the production request data.

Upon receiving the production request data, the manufacturers 21 produce the parts or the like in accordance with the request and deliver the parts on the due delivery time. The packing box manufactures 22 receive the packing box data and deliver packing boxes specified by the data on the due delivery time.

The packing and shipping management server 10 has a packing instruction creating unit (packing instruction creating means) 11, a packing work check unit 12, a transportation instruction creating unit 13, and a document producing unit 14 to assist and manage packing/shipping work in accordance with order information, production request data, packing box data, and a parts-packing box correspondence table. The packing and shipping management server 10 is set on, for example, a site where packing work takes place.

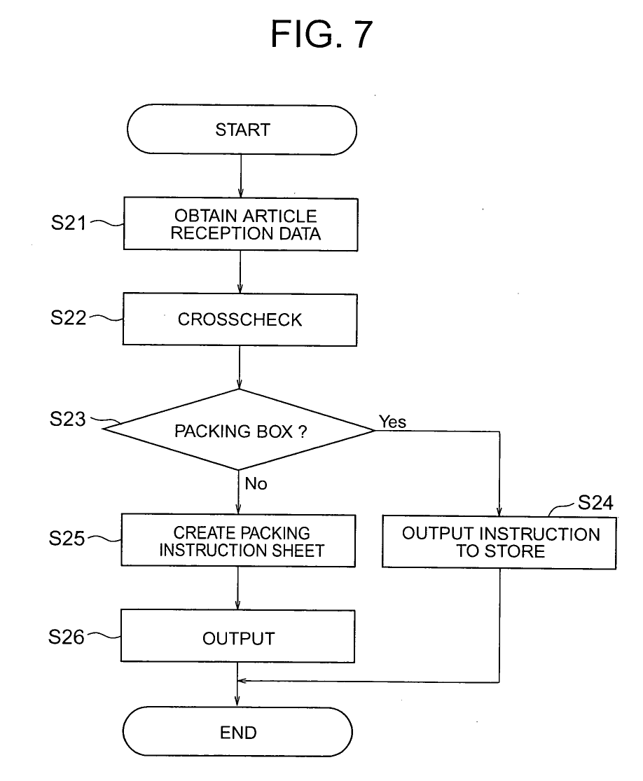

FIG. 7 is a flow chart showing the operation of the packing instruction creating unit 11. The processing shown in FIG. 7 is implemented as requested parts are delivered from the manufacturers 21 or as requested packing boxes are delivered from the packing box manufacturers 22.

In step S21, article reception data is obtained. Articles delivered from the manufacturers 21 or from the packing box manufacturers 22 each have identification information such as a bar code attached thereto, and a bar code reader communicable with the packing and shipping management server 10 is used to read the bar code and obtain article reception data. Article reception data includes, for example, information indicative of the contents (such as the model of parts), the quantity, and manufacturer name, and the like.

In steps S22 and S23, the articles received are recognized based on the article reception data, which is checked against the production request data or the packing box data, to confirm whether or not correct parts or packing boxes have been delivered as requested. The system may be designed to output a warning message at this point if the articles are not received as requested.

Upon reception of packing boxes, a message is outputted in step S24 which gives an instruction to keep the received packing boxes in a predetermined location. On the other hand, upon reception of parts to be shipped, a packing instruction sheet is created and outputted in steps S25 and S26.

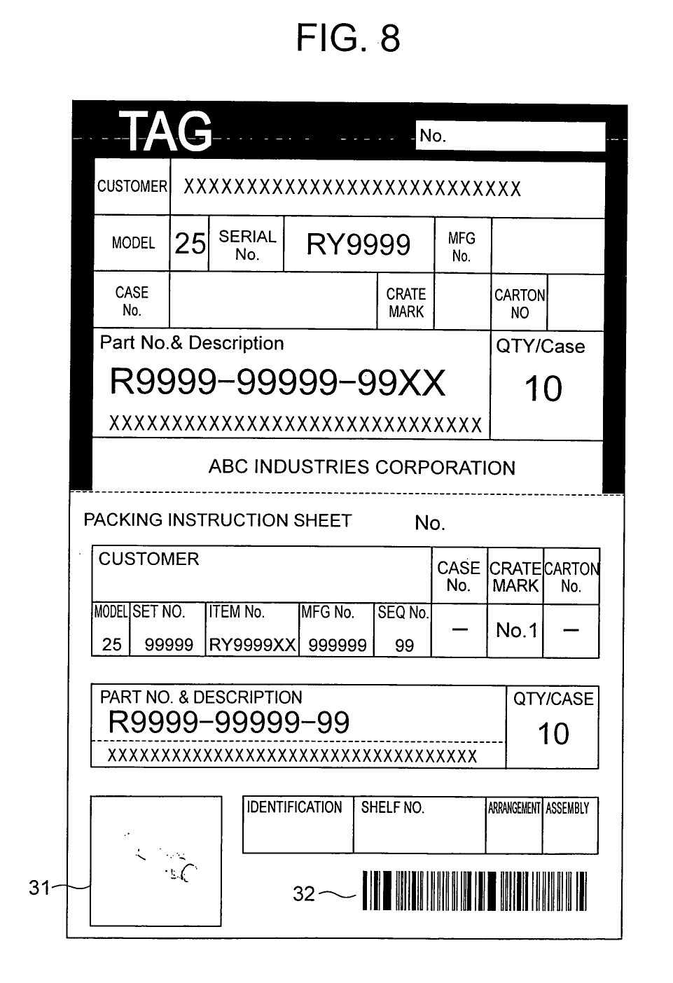

The packing instruction sheet contains instructions to a worker who carries out packing work as shown in FIG. 8. The packing instruction sheet may be printed on paper or the like, or may be displayed on a PDA or the like carried by the packing worker. When the packing instruction sheet is printed on paper or the like, a “tag” to be attached to an external surface of the packing box may be created together with the instruction sheet.

In addition to the model and quantity of parts to be shipped, information that specifies the packing box to be used is written in the packing instruction sheet. In FIG. 8, the instruction sheet specifies the use of a wooden box (crate mark: No. 1). As described above, what packing box is to be used is determined by the type of parts to be shipped, the delivery destination, the mode of transportation, and the like. An image region 31 holds an image of parts to be shipped. This enables the worker to visually recognize the shape and other features of parts and thus avoid packing wrong parts. Image data of parts to be shipped is obtained from, for example, the specification database 2. Also included in the packing instruction sheet is a bar code 32 for identification of the contents of the packing box.

Upon receiving the packing instruction sheet, a packing worker packs received parts in the packing box specified by the instruction sheet. After the packing work is finished, the worker sticks a corresponding tag to the packing box and uses a bar code reader to read the bar code 32 attached to the packing instruction sheet. The bar code information read by the bar code reader is transferred to the packing work check unit 12 of the packing and shipping management server 10. In this way, the packing and shipping management server 10 keeps track of the progress of packing work.

As has been described, in the packing and shipping management system of this embodiment, the packing instruction sheet is created immediately after parts to be shipped are delivered from the manufacturers 21, and is given to a worker who carries out packing work. The worker follows instructions on the instruction sheet and packs in a packing box the parts that have just arrived. In short, parts to be shipped are packed without being kept in a warehouse or the like. Therefore, the packing and shipping management system of this embodiment requires substantially no stock, eliminating the need for storage space and database or the like for the management of inventory.

As completion of packing work is confirmed, the transportation instruction creating unit 13 of the packing and shipping management server 10 creates and outputs a transportation instruction sheet, which gives instructions regarding which package is loaded into which truck, and so on. Similar to the packing instruction sheet, the transportation instruction sheet may be printed on paper or the like to be handed to a worker or may be displayed on a PDA or the like carried by a worker.

The document producing unit 14 produces and outputs, for example, a document to be submitted to the Customs when parts are to be shipped abroad. In this case, the document producing unit 14 outputs a document obtained by filling out a format prepared in advance.

As has-been described, the packing and shipping management system of this embodiment creates instructions for packing work and shipping work in conjunction with reception of an order placed by a customer and production management of ordered parts, and therefore can pack and ship the parts immediately after the parts to be shipped come in. The system thus makes it possible to realize a business operation mode that requires no inventory.

The above embodiment takes as an example a case in which an order for a product is placed by a customer and parts constituting the product are shipped to the customer. However, the present invention is not limited to this. The present invention is also applicable to a case in which parts are shipped upon receiving an order for the parts from a customer, a case of collecting a product that is assembled by a manufacturer and then shipping the product to a customer that has placed an order for the product, and other cases.

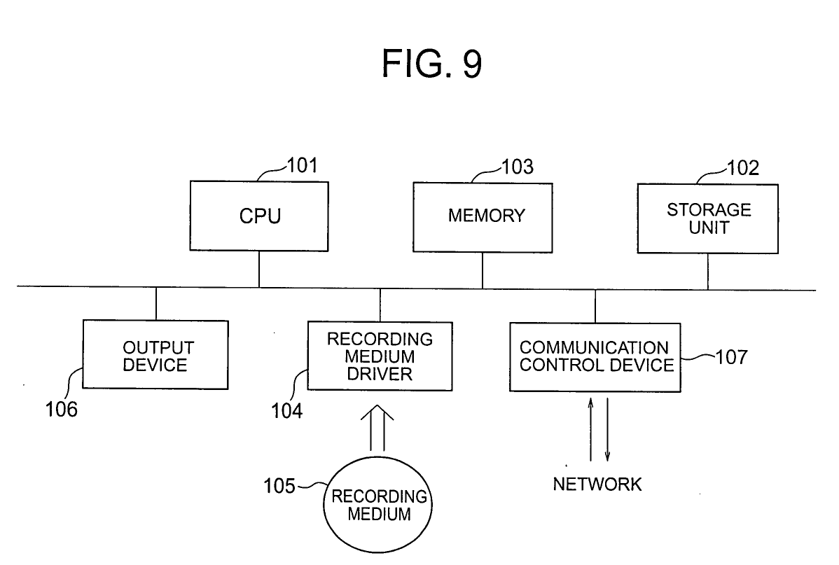

FIG. 9 is a block diagram of a computer for running the packing and shipping management system of this embodiment. Note that the packing and shipping management system may be run by plural computers connected to each other through LAN or the like, although FIG. 9 shows only one computer.

A CPU 101 loads a program in which the processing shown in the above flow charts is written from a storage unit 102 into a memory 103, and executes the program. The storage unit 102 is, for example, a hard disk and stores the program. Alternatively, the storage unit 102 may be an external storage unit connected to the computer. The memory 103 is, for example, a semiconductor memory and is used as the work area of the CPU 101.

A recording medium driver 104 accesses a detachable recording medium 105 following instructions from the CPU 101. The recording medium 105 includes, for example, a semiconductor device (PC card or the like), a medium which uses magnetic effects to input and output information (a flexible disk, a magnetic tape, or the like), and a medium which uses optical effects to input and output information (an optical disk or the like).

An output device 106 is, for example, a printer or a display device. The packing instruction sheet shown in FIG. 8 can be outputted by the output device 106. A communication control device 107 transmits and receives data via a network following instructions from the CPU 101. The communication control device 107 is also capable of exchanging information with a bar code reader used by a worker.

The technical concept of the present invention is applicable not only to a packing and shipping management system but also to a packing and shipping management method in a similar manner.

What is claimed is:

1. A packing and shipping management system comprising:
order reception management means for creating order information in accordance with an order placed by a customer;
production management means for ordering articles to be shipped based on the order information; and
packing instruction creating means for creating and outputting packing instructions in accordance with the order information upon reception of the ordered articles to be shipped, the packing instructions instructing a packing worker on how the articles are to be packed.

2. A packing and shipping management system according to claim 1,
wherein the production management means places an order for a packing box in which articles to be shipped are packed in accordance with the order information, and
wherein the packing instruction creating means outputs the packing instructions which contains information specifying what packing box is to be used.

3. A packing and shipping management system according to claim 2, further comprising an article-packing box correspondence table which registers, for each article to be shipped, information specifying what packing box is to be used in packing articles and information indicating a maximum number of the articles that can be packed in the packing box,
wherein the production management means determines a type and number of packing boxes to order by consulting the article-packing box correspondence table.

4. A packing and shipping management system according to claim 3, wherein the article-packing box correspondence table registers, for each mode of transportation for each article to be shipped, the information specifying what packing box is to be used in packing articles and the information indicating a maximum number of the articles that can be packed in the packing box.

5. A packing and shipping management system according to claim 1, wherein the packing instruction creating means indicates the packing instructions on an instruction sheet that is to be handed to a packing worker.

6. A packing and shipping management system according to claim 5, wherein the instruction sheet is printed together with a tag to be attached to an external surface of the packing box.

7. A packing and shipping management system according to claim 1, wherein the packing instruction includes images of the articles to be shipped.

8. A packing and shipping management method which uses a computer to manage a process starting from reception of an order placed for an article by a customer and ending with shipment of the ordered article,
the method comprising the following steps performed by the computer:
creating order information in accordance with the order placed by the customer;
ordering the article to be shipped based on the order information; and
creating and outputting packing instructions in accordance with the order information upon reception of the ordered articles to be shipped, the packing instructions instructing a packing worker on how the articles are to be packed.
